(19) United States
(12) Patent Application Publication
(10) Pub. No.: US 2026/0106397 A1
(43) Pub. Date: Apr. 16, 2026

(54) HYBRID BOARD-AND-CABLE CONNECTOR FOR HIGH-CURRENT, LOW-CURRENT, AND SIGNAL TRANSMISSION

(71) Applicant: FCI CONNECTORS DONGGUAN LTD., Dongguan City (CN)

(72) Inventors: Yilin Liu, Dongguan (CN); Yiheng Wang, Dongguan (CN)

(73) Assignee: FCI CONNECTORS DONGGUAN LTD., Dongguan City (CN)

(21) Appl. No.: 19/355,082

(22) Filed: Oct. 10, 2025

(30) Foreign Application Priority Data
Oct. 14, 2024 (CN) 202411475529.9
Oct. 14, 2024 (CN) 202422548570.6

(51) Int. Cl. H01R 13/35; H01R 12/70; H01R 12/71; H01R 12/75

(52) U.S. Cl. CPC H01R 13/35; H01R 12/7047; H01R 12/707; H01R 12/7082; H01R 12/7088; H01R 12/716; H01R 12/75

(57) ABSTRACT

A hybrid board-and-cable electrical connector for high-current, low-current, and signal transmission. The connector includes a board-side connector module and a cable-side connector module detachably coupled together. The board-side module includes a housing having first and second cavities respectively receiving high-power terminals and signal wafers. Each high-power terminal includes an elastic arm and a tail portion for board connection, and each signal wafer includes signal terminals for signal transmission. The cable-side module includes low-power terminal subassemblies with corresponding terminal position assurance (TPA) devices.

Coordinated engagement between position-limiting slots, projections, and elastic arms stabilizes the terminals and wafers, enabling reliable high-current and signal transmission, convenient assembly and maintenance, and enhanced heat dissipation. The techniques described herein can provide a modular and configurable connector architecture in which high-power terminals, low-power terminals, and signal terminals are structurally combined to achieve reliable electrical and mechanical performance.

### CROSS-REFERENCE TO RELATED APPLICATIONS

This application claims priority to and the benefit of Chinese Patent Application No. 202411475529.9, filed on Oct. 14, 2024. This application also claims priority to and the benefit of Chinese Patent Application No. 202422548570.6, filed on Oct. 14, 2024. The contents of these applications are incorporated herein by reference in their entirety.

### TECHNICAL FIELD

The present disclosure relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several electronic subassemblies is to provide a backplane. A known backplane is a PCB onto which many connectors may be mounted. Conducting traces in the backplane may be electrically connected to signal conductors in the connectors such that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore bend through a right angle and are often called “right angle connectors.”

Connectors may also be used in other configurations for interconnecting electronic assemblies. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

### SUMMARY

Aspects of the present disclosure relate to hybrid board-and-cable connector for high-current, low-current, and signal transmission.

Some embodiments relate to an electrical connector. The electrical connector may include comprising a first module and a second module detachably attached to one side of the first module. The first module may comprise a first module housing comprising a plurality of first cavities and a plurality of second cavities disposed in parallel along a longitudinal direction of the first module housing, a plurality of first terminals each at least partially disposed in a respective first cavity of the plurality of first cavities, each of the plurality of first terminals comprising a mating end, and a tail portion configured for board termination, and a plurality of wafers each at least partially disposed in a respective second cavity of the plurality of second cavities, each of the plurality of wafers comprising a wafer housing and a plurality of second terminals held by the wafer housing, each of the plurality of second terminals comprising a mating end, and a tail configured for board termination. The second module may comprise a plurality of third terminals configured for cable termination.

Optionally, the first housing comprises a groove; and the second module comprises a second housing comprising a block configured to engage the groove of the first housing.

Optionally, the block is dovetail-shaped.

Optionally, the first housing comprises a plurality of convex ribs on inner sidewalls of the first and second cavities.

Optionally, each of the plurality of first cavities comprises a first position-limiting slot; and each of the plurality of first terminals comprises a first elastic arm extending into the first position-limiting slot in a respective first cavity.

Optionally, each of the plurality of first terminals comprises one or more detents at a top and/or bottom of the first terminal.

Optionally, the electrical connector further comprises a polyester film disposed on an upper surface of the first housing.

Optionally, each of the plurality of second cavities comprises a second position-limiting slot; and the wafer housing comprises a second elastic arm extending into the second position-limiting slot in a respective second cavity.

Optionally, each of the plurality of second cavities comprises a third position-limiting slot on an inner sidewall; and the wafer housing comprises a projection disposed in the third position-limiting slot.

Optionally, the electrical connector may further comprise first and second guiding members disposed on the first housing of the first module and the second housing of the second module, respectively.

Optionally, each of the plurality of first terminals is configured to carry a first maximum current; each of the plurality of second terminals is configured for signal transmission; and each of the plurality of third terminals is configured to carry a second maximum current less than the first maximum current.

Some embodiments relate to a connector module for board termination. The connector module may include a module housing comprising a plurality of first cavities and a plurality of second cavities, each of the plurality of first cavities comprising a first position-limiting slot and a second position-limiting slot, each of the plurality of second cavities comprising a third position-limiting slot; a plurality of high-power terminals disposed in the plurality of first cavities, each of the plurality of high-power terminals comprising a first elastic arm extending into the first position-limiting slot of a respective first cavity, a first projection engaging the second position-limiting slot of the respective first cavity, and a tail portion extending beyond the module housing; and a plurality of signal wafers disposed in the plurality of second cavities, each signal wafer comprising a wafer housing and a plurality of signal terminals, the wafer housing comprising a second elastic arm engaging the third position-limiting slot of a respective second cavity.

Optionally, each of the plurality of second cavities comprises a fourth position-limiting slot on an inner sidewall; and the wafer housing of each of the plurality of signal wafer comprises a second projection on an outer sidewall engaging the fourth position-limiting slot.

Optionally, the module housing comprises convex ribs extending in parallel on inner walls of the first cavities and second cavities and configured to enhance stability and heat dissipation.

Optionally, each of the plurality of high-power terminals comprises a tail portion comprising a plurality of tails aligned in a first line; each of the plurality of signal terminals comprises a tail; and the tails of the plurality of signal terminals of each of the plurality of signal wafers are aligned in a second line parallel to the first line.

Some embodiments relate to a connector module for cable termination. The connector module may include a module housing comprising a plurality of cavities disposed in parallel along a longitudinal direction of the module housing, each of the plurality of cavities comprising first and second slots; a plurality of terminals disposed in the cavities, each of the plurality of terminals comprising a mating end and a tail; and a plurality of terminal position assurance (TPA) devices, each of the plurality of TPA devices inserted between the first and second slots of a respective cavity of the module housing.

Optionally, each of the plurality of TPA devices extends through the first slot into the second TPA slot of the respective cavity, positioning the TPA device and a respective terminal side by side.

Optionally, each of the plurality of terminals comprises a tab snapped into engagement with the TPA device.

Optionally, the connector module further comprises a plurality of cables, each of the plurality of cables comprising an end attached to the tail of a respective terminal of the plurality of terminals.

Optionally, the module housing comprises a block on a side and configured to engaging a complementary groove of a connector module configured for board termination, and a guiding member on a top and configured to engage a complementary guiding feature of a mating connector module.

Some embodiments relate to a hybrid board-and-cable connector configured to support high current. The connector may comprise a board-side connector module and a cable-side connector module. The cable-side connector module may be detachably provided on one side of the board-side connector module. The board-side connector module may comprise a board-side module housing, a plurality of high-power terminals and a plurality of signal wafers. A plurality of first accommodating cavities and a plurality of second accommodating cavities arranged in sequence and parallel along a length direction of the board-side module housing may be provided in the board-side module housing. The high-power terminals and the signal wafers may be respectively disposed in the first accommodating cavities and the second accommodating cavities. A first position-limiting slot may be provided on an upper end of the first accommodating cavity. A first elastic arm may be provided at one end of the high-power terminal adjacent to the first position-limiting slot. The first elastic arm may obliquely extend away from the high-power terminal into the first position-limiting slot. A tail portion may be provided at one end of the high-power terminal away from the first elastic arm. The tail portion may extend downward to the outside of the board-side module housing.

Optionally, a second position-limiting slot is provided on an inner sidewall of the first accommodating cavity, and a first projection corresponding to the second position-limiting slot is provided on an outer sidewall of the high-power terminal, and the first projection extends away from the high-power terminal into the second position-limiting slot.

Optionally, a detent is respectively provided at upper and lower ends of the high-power terminal, and the two detents are respectively located on one side of the first elastic arm and the tail portion.

Optionally, the signal wafer comprises a wafer housing and a group of signal terminals provided in the wafer housing; a first end of the group of signal terminals extends downward to the outside of the wafer housing towards a lower side away from the wafer housing, and a second end of the group of signal terminals extends toward a lateral side of the wafer housing and extends to the outside of the wafer housing.

Optionally, a third position-limiting slot is respectively provided on two inner sidewalls of the second accommodating cavity, and a second projection corresponding to the third position-limiting slot is provided on an outer sidewall of the wafer housing, and the second projection extends away from the wafer housing into the third position-limiting slot.

Optionally, a fourth position-limiting slot is provided on an upper end of the second accommodating cavity, a second elastic arm corresponding to the fourth position-limiting slot is provided on the upper end of the wafer housing, and the second elastic arm extends upward into the fourth position-limiting slot towards an upper side away from the wafer housing.

Optionally, the cable-side connector module comprises a cable-side module housing and a plurality of low-power terminal subassemblies; a plurality of third accommodating cavities arranged in parallel along a length direction of the cable-side module housing are provided in the cable-side module housing, and the low-power terminal subassemblies are inserted into the third accommodating cavities; the low-power terminal subassembly comprises a low-power terminal and a cable, and the low-power terminal is located in the cable-side module housing; one end of the cable is connected to the low-power terminal, and the other end extends to the outside of the cable-side module housing.

Optionally, a first TPA slot is provided on an upper side of the third accommodating cavity, a second TPA slot corresponding to the first TPA slot is provided at a bottom of the third accommodating cavity, and a TPA is inserted between the first TPA slot and the second TPA slot; a tab is provided on a side of the low-power terminal adjacent to the TPA, and the tab is snapped on a side of the TPA away from the cable.

Optionally, a guiding member is provided on each of the board-side module housing and the cable-side module housing.

Optionally, a circuit board is connected below the board-side connector module and the cable-side connector module, and the circuit board is provided with a first contact pad and a second contact pad; one end of the tail portion located outside the board-side module housing is electrically connected inside the first contact pad, and a first end of the group of signal terminals extends downward to the outside of the wafer housing towards a lower side away from the wafer housing, and is electrically connected inside the second contact pad.

Optionally, a groove is provided at one end of the board-side module housing, the cable-side connector module is provided with a block corresponding to the groove, and the cable-side connector module is connected through the snap-fit connection of the groove with the block.

Some embodiments relate to a hybrid board-and-cable connector configured to support high current. The connector may comprise a board-side connector module and a cable-side connector module. The board-side connector module may be detachably connected to the side connector module. The board-side connector module may comprise a board side module housing, a high-power terminal, and a signal wafer. The high-power terminal and the signal wafer each may include a limiting structure to respectively mount the high-power terminal and the signal wafer in the board side module housing. The cable-side connector module may comprise a cable side module housing, a low-power terminal and a cable. The low-power terminal may be mounted in the cable side module housing through a TPA. The cable may be provided and connected on the low-power terminal.

Optionally, a circuit board is further comprised, and the board-side connector module is soldered on the circuit board.

Optionally, a side of the cable-side connector module is mounted with the board-side connector module through a block, and the cable-side connector module is mounted on the circuit board through a fastener.

Optionally, the fastener penetrates the cable-side connector module and the circuit board for mounting.

Optionally, a detent, a first elastic arm and a first projection are provided on the high-power terminal to form the limiting structure to mount the high-power terminal in the board side module housing.

Optionally, a second elastic arm and a second projection are provided on the signal wafer to form the limiting structure to mount the signal wafer in the board side module housing.

Optionally, positioning convex ribs are provided on the board side module housing to position and mount the signal wafer.

These techniques may be used alone or in any suitable combination. The foregoing summaries are provided by way of illustration and are not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a perspective view of a hybrid board-and-cable connector, showing a portion of a circuit board to which the connector may be mounted, according some embodiments.

FIG. 1B is another perspective view of the hybrid board-and-cable connector of FIG. 1A.

FIG. 2 is a partially exploded perspective view of the hybrid board-and-cable connector of FIG. 1A.

FIG. 3 is a perspective view of a board-side connector module of the hybrid board-and-cable connector of FIG. 1A.

FIG. 4 is a top view of the board-side connector module of FIG. 3.

FIG. 5 is a perspective view of a board-side module housing of the board-side connector module of FIG. 3.

FIG. 6 is an enlarged perspective view of a region within a circle marked “A” in FIG. 5.

FIG. 7 is an enlarged perspective view of a region within a circle marked “B” in FIG. 5.

FIG. 8A is a perspective view of a high-power terminal of the board-side connector module of FIG. 3.

FIG. 8B is another perspective view of the high-power terminal of FIG. 8A.

FIG. 9A is a perspective view of a signal wafer of the board-side connector module of FIG. 3.

FIG. 9B is a perspective view of a wafer housing of the signal wafer of FIG. 9A.

FIG. 10 is a perspective view of signal terminals of the signal wafer of FIG. 9A.

FIG. 11A is a perspective view of a cable-side connector module.

FIG. 11B is a cross-sectional view of the cable-side connector module of FIG. 11A.

### DETAILED DESCRIPTION

The inventors have recognized and appreciated connector design techniques that enable hybrid board-and-cable connectors for applications involving high-current, low-current, and/or signal transmission. The inventors have also recognized and appreciated challenges in integrating terminals configured for different purposes in a single connector, as such terminals may require different retention forces. The techniques described herein may address these challenges by, for example, providing a modular and configurable connector architecture in which high-power terminals, low-power terminals, and signal terminals are structurally combined to achieve reliable electrical and mechanical performance. In some embodiments, the modular units (e.g., high-power terminals, signal wafers) may be mechanically and dimensionally compatible, such that their arrangement within the connector housing may be selected or altered according to application needs without affecting overall fit or function. Accordingly, the order of multiple modular units may be arbitrary, yet the resulting combination may maintain robust mechanical engagement and electrical connectivity.

According to aspects of the present disclosure, an electrical connector may include a board-side connector module and a cable-side connector module. The board-side connector module may be detachably connected to the cable-side connector module. Accordingly, the board-side connector module can be adapted for use with a variety of cable-side connector modules to meet the functional requirements of individual applications. Furthermore, the retention force of the respective terminals within the board-side or cable-side connector modules may be enhanced to reduce the risk of the connector damage during use, thereby extending the service life of the connector.

In some embodiments, the board-side connector module may include a board-side module housing, a high-power terminal, and a signal wafer. A first accommodating cavity and a second accommodating cavity may be provided in the board-side module housing. A first position-limiting slot may be provided on an upper end of the first accommodating cavity. A first elastic arm may be provided at one end of the high-power terminal adjacent to the first position-limiting slot. A tail portion may be provided at one end of the high-power terminal away from the first elastic arm.

The coordinated configuration of these components may enable the connector to satisfy high-current transmission requirements of high-power devices while ensuring stable power delivery and convenient assembly and disassembly between the board-side connector module and the cable-side connector module, thereby improving the installation and maintenance efficiency. Moreover, the connector structure can be readily upgraded and/or expanded by selectively replacing components of the board-side or cable-side connector modules to accommodate evolving connection requirements of various devices.

In some embodiments, the first accommodating cavity may include a second position-limiting slot. The high-power terminal may include a first projection corresponding to the second position-limiting slot. The coordinated configuration of the second position-limiting slot and the first projection can reduce the risk of the high-power terminal rotating, offsetting and moving relative to the first accommodating cavity when subjected to external force, thereby further improving the connection stability between the high-power terminal and the board-side module housing.

In some embodiments, detents may be respectively provided at upper and lower sides of the high-power terminal. Through the synergistic effect of the two detents, the high-power terminal may be more stable in the first accommodating cavity. This configuration may reduce the risk of a high-power terminal escaping from the first accommodating cavity when subjected to external force, thereby enhancing connection stability between the high-power terminal and the board-side module housing.

In some embodiments, the signal wafer may include a wafer housing and a group of signal terminals. The coordinated configuration of the wafer housing and the group of signal terminals can enable the group of signal terminals to be stably positioned in the second accommodating cavity and reduce the risk of the signal interferences among adjacent groups of signal terminals.

In some embodiments, a third position-limiting slot may be respectively provided on an inner sidewall of the second accommodating cavity. A second projection corresponding to the third position-limiting slot may be provided on an outer sidewall of the wafer housing. The coordinated configuration of the third position-limiting slot and the second projection can reduce the risk of the signal wafer rotating, offsetting and moving relative to the second accommodating cavity when subjected to external force, thereby improving the connection stability between the signal wafer and the board-side module housing.

In some embodiments, a fourth position-limiting slot may be provided at an upper end of the second accommodating cavity. A second elastic arm corresponding to the fourth position-limiting slot may be provided at an upper end of the wafer housing. The coordinated configuration of the fourth position-limiting slot and the second elastic arm can reduce the risk of the signal wafer escaping from the second accommodating cavity when subjected to external force, thereby further improving the connection stability between the signal wafer and the board-side module housing.

In some embodiments, the third accommodating cavity may include a first TPA slot and a second TPA slot. A terminal position assurance (TPA) device may be inserted between the first TPA slot and the second TPA slot. A tab may be provided on a side of the low-power terminal adjacent to the TPA. The coordinated use of the above constituting parts may reduce the risk of the low-power terminal escaping from the third accommodating cavity when subjected to external force, thereby improving the connection stability between the low-power terminal and the cable-side module housing.

In some embodiments, a guiding member may be provided on each of the board-side module housing and the cable-side module housing. When mating with another connector, the guiding member and a complementary guiding feature (e.g., a guiding hole) of the mating connector can provide alignment and positioning, thereby improving the alignment accuracy and overall assembly efficiency.

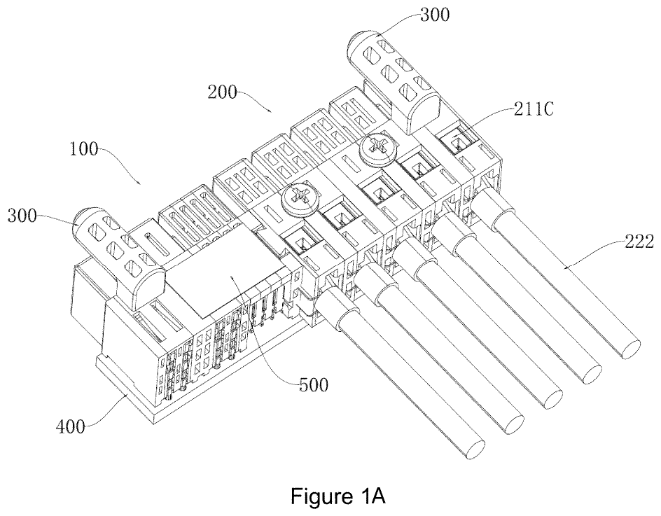

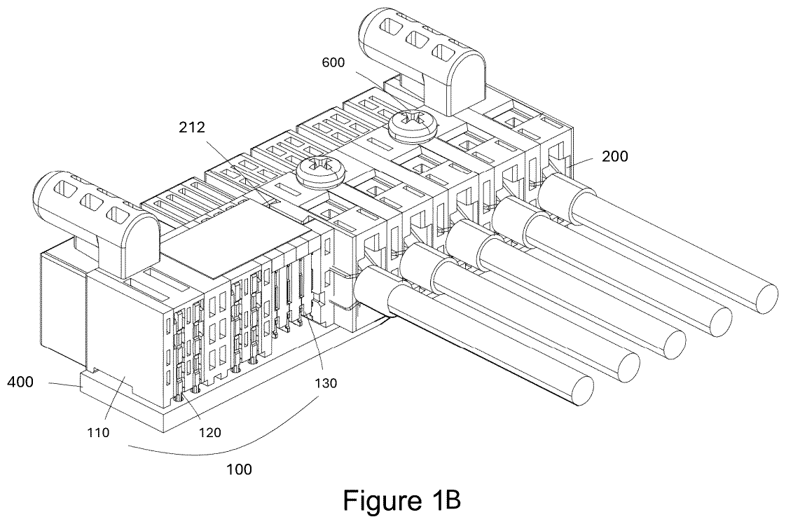

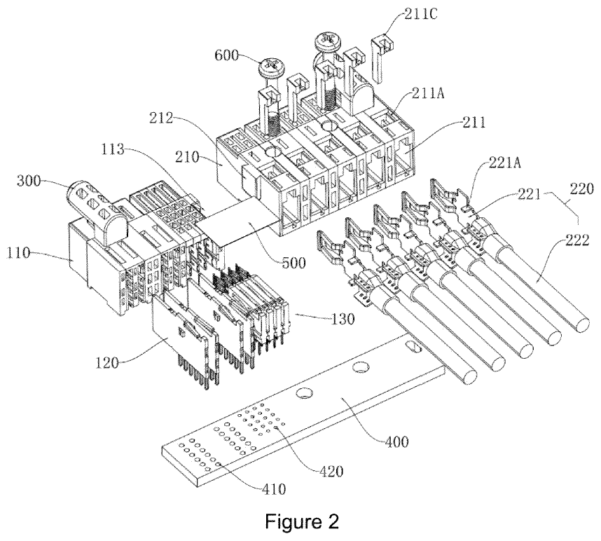

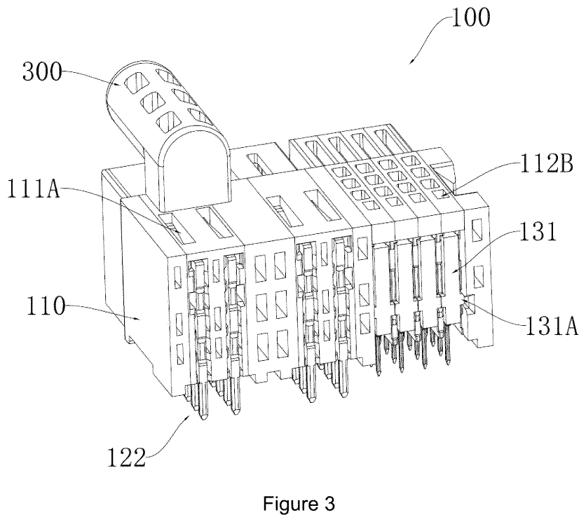

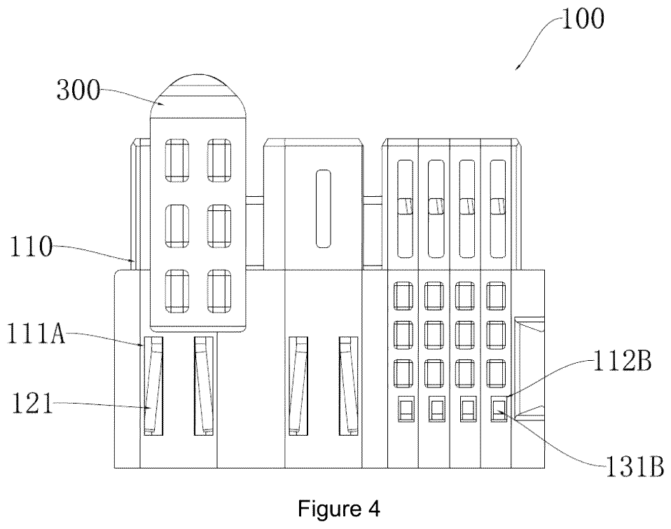

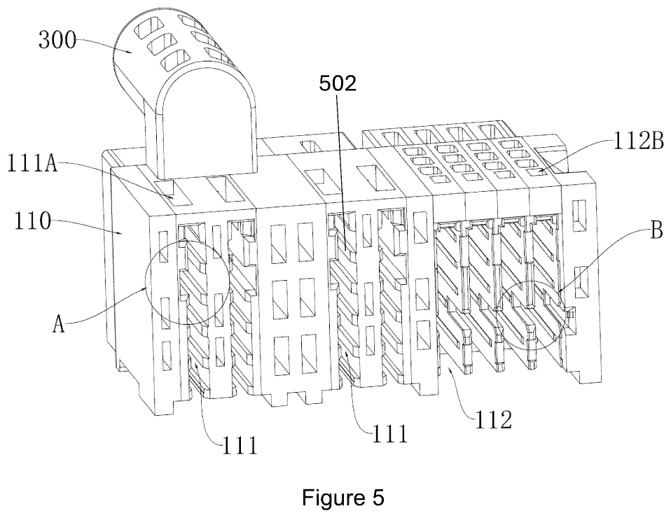

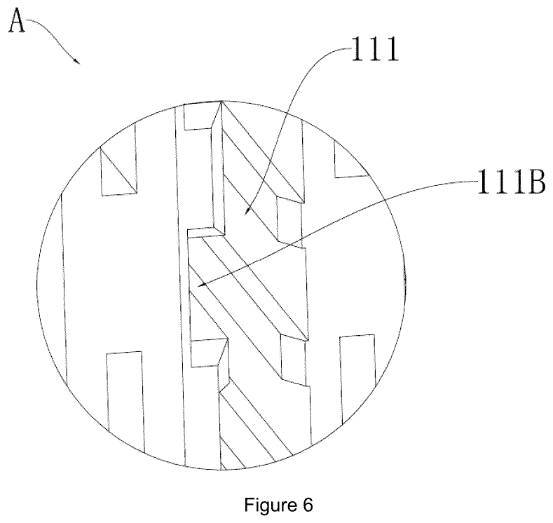

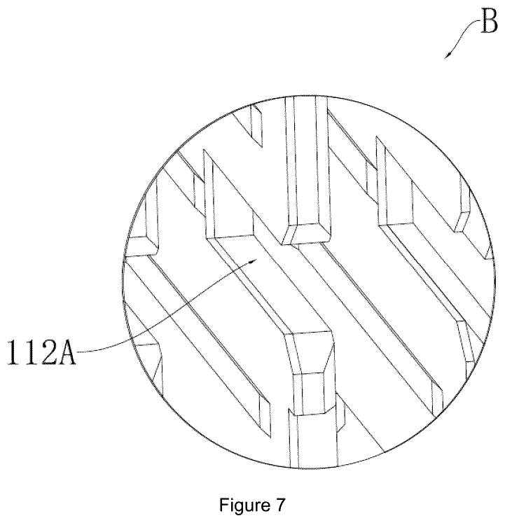

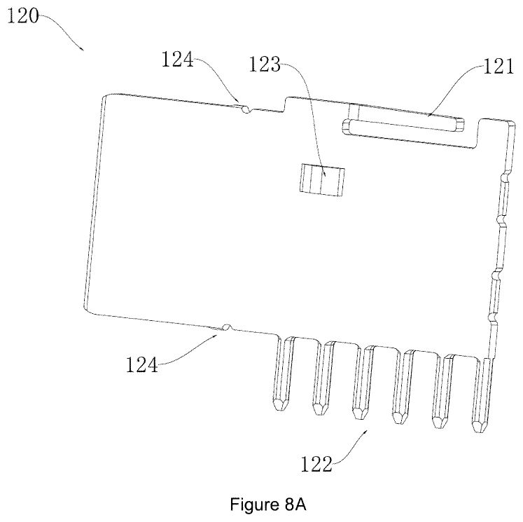

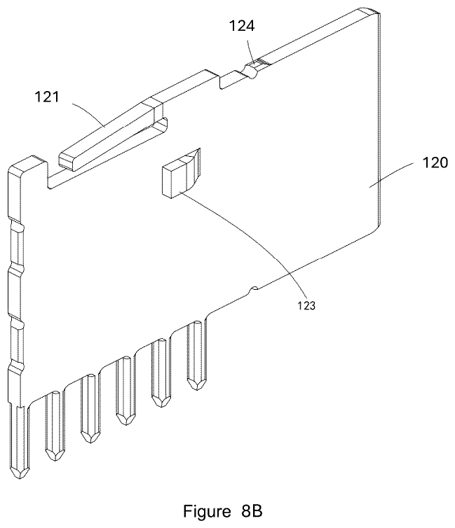

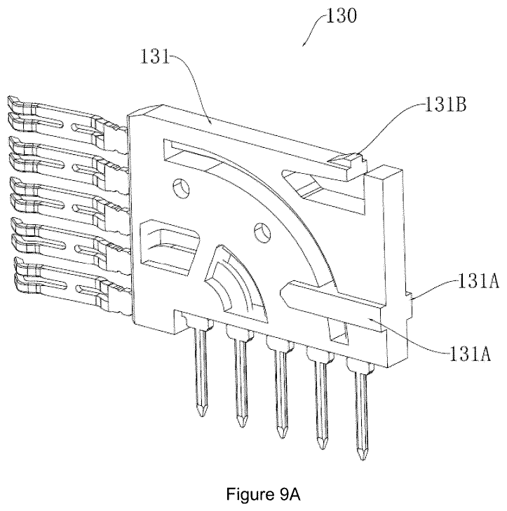

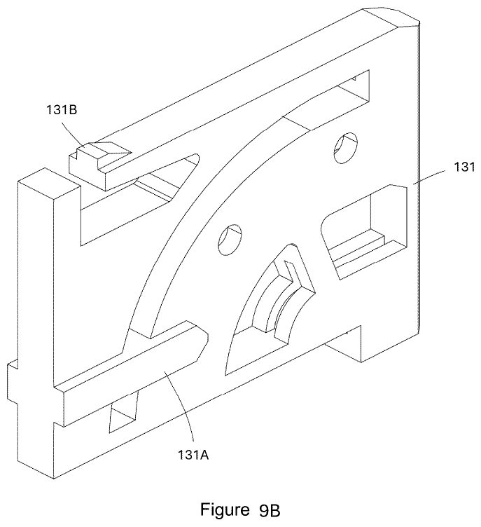

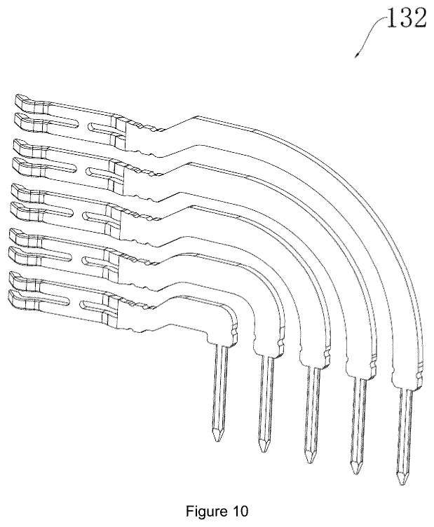

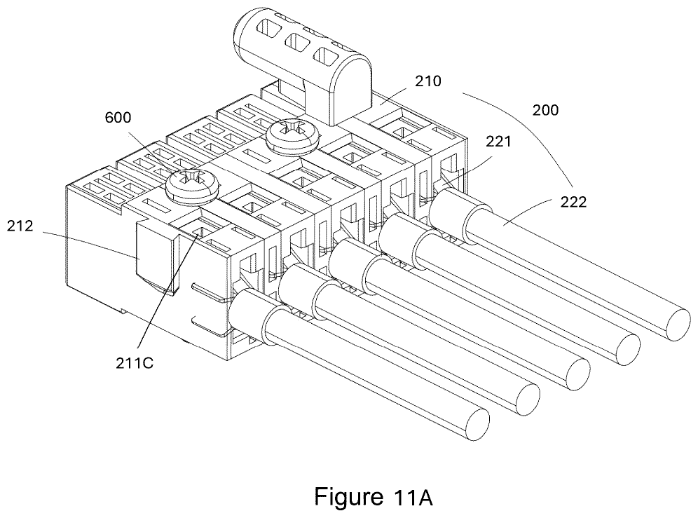

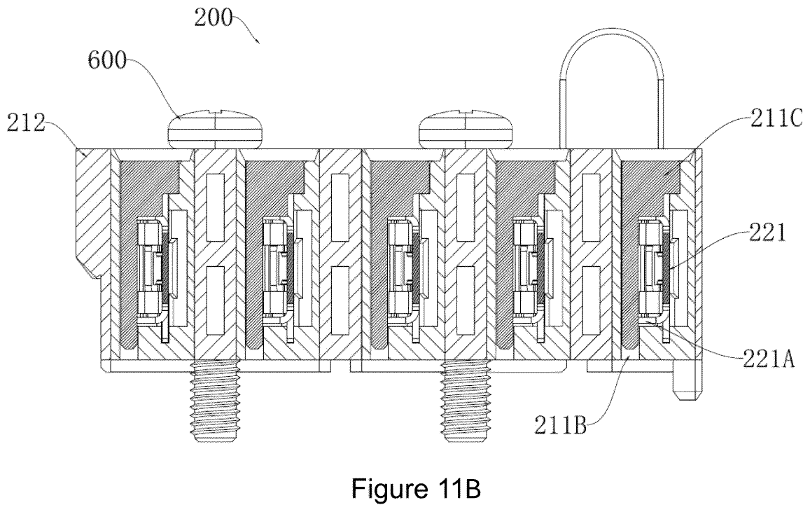

Referring to FIGS. 1A to 11B, an embodiment of the present application provides a hybrid board-and-cable connector configured to support high current. The connector may comprise a board-side connector module 100 and a cable-side connector module 200. The cable-side connector module 200 may be detachably provided on one side of the board-side connector module 100. The board-side connector module 100 may comprise a board-side module housing 110, a plurality of high-power terminals 120, and a plurality of signal wafers 130. The module housing 110 may define a plurality of first accommodating cavities 111 and a plurality of second accommodating cavities 112 arranged sequentially and in parallel along a length direction of the board-side module housing 110. The high-power terminals 120 and the signal wafers 130 may be respectively disposed in the first accommodating cavities 111 and the second accommodating cavities 112.

A first position-limiting slot 111A may be provided on an upper end of the first accommodating cavity 111. A first elastic arm 121 may be provided on one side of the high-power terminal 120 adjacent to the first position-limiting slot 111A, and the first elastic arm 121 may obliquely extend away from the high-power terminal 120 and into the first position-limiting slot 111A. A tail portion 122 may be provided at one end of the high-power terminal 120 away from the first elastic arm 121, and the tail portion 122 may extend downward to the outside of the board-side module housing 110. In some embodiments, the high-power terminal 120 may be configured to carry high power, and the signal wafer 130 may be configured to transmit signals.

The coordinated configuration of the above components enables the connector to satisfy high-current transmission requirements of high-power devices, provide stable power delivery, and facilitate convenient assembly and disassembly between the board-side connector module 100 and the cable-side connector module 200 t, thereby improving installation and maintenance efficiency. In addition, the connector can be readily upgraded and/or expanded by replacing components of the board-side connector module 100 and/or the cable-side connector module 200 to meet evolving application needs.

In some embodiments, a groove 113 may be provided at one end of the board-side module housing 110, and a corresponding block 212 (which may be dovetail shaped) may be provided at the cable-side module housing 210 of the cable-side connector module 200. By snap-fitting the block 212 into the groove 113, the cable-side connector module 200 can be detachably mounted to the board-side connector module 100. Accordingly, the board-side connector module 100 and the cable-side connector module 200 can be disassembled or replaced separately without replacing the entire connector, thereby reducing maintenance costs and time. By providing a plurality of first accommodating cavities 111 and second accommodating cavities 112, it is facilitated to assemble the high-power terminal 120 and the signal wafer 130 in the board-side module housing 110.

A plurality of convex ribs may be spaced apart and arranged in parallel on the inner sidewalls of the first accommodating cavity 111 and the second accommodating cavity 112. These ribs can improve connection stability between the high-power terminals 120 and the signal wafers 130, and provide heat dissipation channels for the high-power terminals 120 and the signal wafers 130, thereby improving the heat dissipation effect.

The tail portion 122 may be configured for connecting with the circuit board 400, and may include a plurality of solder terminals arranged in parallel along the length direction of the end of the high-power terminal 120, which can reduce the contact resistance and improve the current carrying capacity. A polyester film 500 may be disposed on the surface of the board-side module housing 110 above the second accommodating cavity 112 and the first accommodating cavity 111 adjacent to the second accommodating cavity 112, which may facilitate automated alignment of the connector with the circuit board during production soldering.

In some embodiments, a second position-limiting slot 111B may be provided on an inner wall of the first accommodating cavity 111. A first projection 123 corresponding to the second position-limiting slot 111B may be provided on an outer wall of the high-power terminal 120, and the first projection 123 may extend away from the high-power terminal 120 into the second position-limiting slot 111B.

The coordinated engagement between the second position-limiting slot 111B and the first projection 123 can reduce the risk of the high-power terminal 120 rotating and offsetting relative to the first accommodating cavity 111 when subjected to external force, thereby further improving the precise positioning and connection stability between the high-power terminal 120 and the board-side module housing 110.

In some embodiments, one or more detents 124 may be provided at the upper and lower ends of the high-power terminal 120, respectively. In the illustrated example, two detents 124 are respectively located on one side of the first elastic arm 121 and the tail portion 122. The detents 124 may cooperate to stabilize the high-power terminal 120 in the first accommodating cavity 111 and enhancing connection stability between the high-power terminal 120 and the board-side module housing 110.

In some embodiments, a signal wafer 130 may include a wafer housing 131 and a group of signal terminals 132 provided in the wafer housing 131. A first end of a signal terminal 132 may extend downward to the outside of the wafer housing 131 towards a lower side away from the wafer housing 131. A second end of the signal terminal 132 may extend toward a lateral side of the wafer housing 131 and extend to the outside of the wafer housing 131. Among them, the first end of the group of signal terminals 132 may be a soldering end configured for soldering with the circuit board 400, and the second end of the group of signal terminals 132 may be a mating end configured for electrical connection with other external connectors. The second accommodating cavity 112 may include a through hole corresponding to the second end of the group of signal terminals 132.

The coordinated configuration of the wafer housing 131 and the group of signal terminals 132 can enable stable positioning of the group of signal terminals 132 in the second accommodating cavity 112, and reduce signal interferences among the groups of signal terminals 132.

In some embodiments, a third position-limiting slot 112A may be provided on an inner sidewalls of the second accommodating cavity 112. A second projection 131A corresponding to the third position-limiting slot 112A may be provided on an outer wall of the wafer housing 131. The second projection 131A may extend into the third position-limiting slot 112A and away from the wafer housing 131.

The engagement between the third position-limiting slot 112A and the second projection 131A can reduce the risk of the signal wafer 130 rotating, offsetting and moving relative to the second accommodating cavity 112 when subjected to external force, thereby improving the connection stability between the signal wafer 130 and the board-side module housing 110.

In some embodiments, a fourth position-limiting slot 112B may be provided on an upper end of the second accommodating cavity 112. A second elastic arm 131B corresponding to the fourth position-limiting slot 112B may be provided on an upper end of the wafer housing 131. The second elastic arm 131B may extend upward to the fourth position-limiting slot 112B towards an upper side away from the wafer housing 131. The second elastic arm 131B is an elastic structure, which is beneficial for the signal wafer 130 to rebound and be snapped in the fourth position-limiting slot 112B after being assembled into the second accommodating cavity 112.

The coordinated configuration of the fourth position-limiting slot 112B and the second elastic arm 131B can reduce the risk of the signal wafer 130 escaping from the second accommodating cavity 112 when subjected to external force, thereby further improving connection stability between the signal wafer 130 and the board-side module housing 110.

In some embodiments, the cable-side connector module 200 may include a cable-side module housing 210 and a plurality of low-power terminal subassemblies 220. The housing 210 may define a plurality of third accommodating cavities 211 arranged in parallel along a length direction of the cable-side module housing 210. The low-power terminal subassemblies 220 may be inserted into the third accommodating cavities 211. A low-power terminal subassembly 220 may include a low-power terminal 221 and a cable 222. The low-power terminal 221 may be disposed in the cable-side module housing 210. One end of the cable 222 may be connected to the low-power terminal 221, and the other end may extend to the outside of the cable-side module housing 210.

The coordinated configuration of these components can facilitate the assembling of the low-power terminal subassembly 220 in the cable-side module housing 210 to achieve reliable cable-to-board connection.

In some embodiments, a first TPA slot 211A may be provided on an upper end of the third accommodating cavity 211, and a second TPA slot 211B corresponding to the first TPA slot 211A may be provided at a bottom of the third accommodating cavity 211. A terminal position assurance (TPA) device 211C may be inserted between the first TPA slot 211A and the second TPA slot 211B. A tab 221A may be provided on a side of the low-power terminal 221 adjacent to the TPA 211C, and the tab 221A may be snapped on a side of the TPA 211C away from the cable 222.

The coordinated configuration of the first and second TPA slots 211A, 211B, the TPA device 211C, and the tab 221A can reduce the risk of the low-power terminal subassembly 220 escaping from the third accommodating cavity 211 when subjected to external force, thereby improving connection stability between the third terminal and the cable-side module housing 210. In some embodiments, the TPA 211C may pass through the first TPA slot 211A and penetrate the third accommodating groove into the second TPA slot 211B. In the illustrated example, the low-power terminal 221 and the TPA 211C are arranged side by side in the third accommodating cavity 211. With the tab 221A provided on the side of the low-power terminal 221 adjacent to the TPA 211C, the tab 221A is snapped with the TPA 211C, so that the low-power terminal 221 is snapped tightly in the third accommodating cavity 211.

In some embodiments, a guiding member 300 may be provided on each of the board-side module housing 110 and the cable-side module housing 210. Since the guiding members 300 are provided on each of the board-side module housing 110 and the cable-side module housing 210, when mating with an external connector, the guiding members 300 may cooperate with corresponding guide holes of the mating connector to provide alignment and positioning, thereby improving alignment accuracy and assembly efficiency.

In some embodiments, a circuit board 400 may be connected below the board-side connector module 100 and the cable-side connector module 200. In the illustrated example, the circuit board 400 is provided with a first contact pad 410 and a second contact pad 420. The end of the tail portion 122 located outside the board-side module housing 110 is electrically connected to the first contact pad 410, and the first end of the group of signal terminals 132 extends downward to the outside of the wafer housing 131 towards a lower side away from the wafer housing 131, and is electrically connected to the second contact pad 420. In some embodiments, the first contact pad 410 and the second contact pad 420 are provided on the

circuit board 400. In some embodiments, the tail portion 122 is soldered into the first contact pad 410 and the first end of the group of signal terminals 132 is soldered into the second contact pad 420, and thus it is realized that the board-side connector module 100 is soldered to the circuit board 400. The block 212 of the cable-side module housing 210 is snapped into the groove 113 on the board-side module housing 110, so that the cable-side connector module 200 is snapped on one side of the board-side connector module 100, and then the cable-side module housing 210 is fixed to the circuit board 400 by a fastener 600, thereby forming a high-current board-side-cable-side combined connector.

Various aspects are described in this disclosure, which include, but may not be limited to, the following aspects:
1. An electrical connector comprising: a first module (e.g., 100) comprising: a first module housing (e.g., 110) comprising a plurality of first cavities (e.g., 111) and a plurality of second cavities (e.g., 112) disposed in parallel along a longitudinal direction of the first module housing, a plurality of first terminals (e.g., 120) each at least partially disposed in a respective first cavity of the plurality of first cavities, each of the plurality of first terminals comprising a mating end, and a tail portion (e.g., 122) configured for board termination, and a plurality of wafers (e.g., 130) each at least partially disposed in a respective second cavity of the plurality of second cavities, each of the plurality of wafers comprising a wafer housing (e.g., 131) and a plurality of second terminals (e.g., 132) held by the wafer housing, each of the plurality of second terminals comprising a mating end, and a tail configured for board termination; and a second module (e.g., 200) detachably attached to one side of the first module, the second module comprising a plurality of third terminals (e.g., 221) configured for cable termination.
2. The electrical connector of aspect 1, wherein the first housing comprises a groove (e.g., 113); and the second module comprises a second housing (e.g., 210) comprising a block (e.g., 212) configured to engage the groove of the first housing.
3. The electrical connector of aspect 2, wherein the block is dovetail-shaped.
4. The electrical connector of aspect 1, wherein the first housing comprises a plurality of convex ribs (e.g., 502) on inner sidewalls of the first and second cavities.
5. The electrical connector of aspect 1, wherein each of the plurality of first cavities comprises a first position-limiting slot (e.g., 111A); and each of the plurality of first terminals comprises a first elastic arm (e.g., 121) extending into the first position-limiting slot in a respective first cavity.
6. The electrical connector of aspect 1, wherein each of the plurality of first terminals comprises one or more detents (e.g., 124) at a top and/or bottom of the first terminal.
7. The electrical connector of aspect 1, further comprising a polyester film (e.g., 500) disposed on an upper surface of the first housing.
8. The electrical connector of aspect 1, wherein each of the plurality of second cavities comprises a second position-limiting slot (e.g., 112B); and the wafer housing comprises a second elastic arm (e.g., 131B) extending into the second position-limiting slot in a respective second cavity.
9. The electrical connector of aspect 8, wherein each of the plurality of second cavities comprises a third position-limiting slot (e.g., 112A) on an inner sidewall; and the wafer housing comprises a projection (e.g., 131A) disposed in the third position-limiting slot.
10. The electrical connector of aspect 1, further comprising first and second guiding members (e.g., 300) disposed on the first housing of the first module and the second housing of the second module, respectively.
11. The electrical connector of aspect 1, wherein each of the plurality of first terminals is configured to carry a first maximum current; each of the plurality of second terminals is configured for signal transmission; and each of the plurality of third terminals is configured to carry a second maximum current less than the first maximum current.
12. A connector module for board termination, comprising a module housing comprising a plurality of first cavities and a plurality of second cavities, each of the plurality of first cavities comprising a first position-limiting slot and a second position-limiting slot, each of the plurality of second cavities comprising a third position-limiting slot; a plurality of high-power terminals disposed in the plurality of first cavities, each of the plurality of high-power terminals comprising a first elastic arm extending into the first position-limiting slot of a respective first cavity, a first projection engaging the second position-limiting slot of the respective first cavity, and a tail portion extending beyond the module housing; and a plurality of signal wafers disposed in the plurality of second cavities, each signal wafer comprising a wafer housing and a plurality of signal terminals, the wafer housing comprising a second elastic arm engaging the third position-limiting slot of a respective second cavity.
13. The connector module of aspect 12, wherein each of the plurality of second cavities comprises a fourth position-limiting slot on an inner sidewall; and the wafer housing of each of the plurality of signal wafer comprises a second projection on an outer sidewall engaging the fourth position-limiting slot.
14. The connector module of aspect 12, wherein the module housing comprises convex ribs extending in parallel on inner walls of the first cavities and second cavities and configured to enhance stability and heat dissipation.
15. The connector module of aspect 12, wherein each of the plurality of high-power terminals comprises a tail portion comprising a plurality of tails aligned in a first line; each of the plurality of signal terminals comprises a tail; and the tails of the plurality of signal terminals of each of the plurality of signal wafers are aligned in a second line parallel to the first line.
16. A connector module for cable termination, comprising a module housing comprising a plurality of cavities disposed in parallel along a longitudinal direction of the module housing, each of the plurality of cavities comprising first and second slots; a plurality of terminals disposed in the cavities, each of the plurality of terminals comprising a mating end and a tail; and a plurality of terminal position assurance (e.g., TPA) devices, each of the plurality of TPA devices inserted between the first and second slots of a respective cavity of the module housing.
17. The connector module of aspect 16, wherein each of the plurality of TPA devices extends through the first slot into the second TPA slot of the respective cavity, positioning the TPA device and a respective terminal side by side.
18. The connector module of aspect 16, wherein each of the plurality of terminals comprises a tab snapped into engagement with the TPA device.
19. The connector module of aspect 16, further comprising a plurality of cables, each of the plurality of cables comprising an end attached to the tail of a respective terminal of the plurality of terminals.
20. The connector module of aspect 16, wherein the module housing comprises a block on a side and configured to engaging a complementary groove of a connector module configured for board termination, and a guiding member on a top and configured to engage a complementary guiding feature of a mating connector module.
21. A hybrid board-and-cable connector configured to support high current, comprising a board-side connector module (e.g., 100) and a cable-side connector module (e.g., 200), wherein the cable-side connector module is detachably provided on one side of the board-side connector module; the board-side connector module comprises a board-side module housing (e.g., 110), a plurality of high-power terminals (e.g., 120), and a plurality of signal wafers (e.g., 130); a plurality of first accommodating cavities (e.g., 111) and a plurality of second accommodating cavities (e.g., 112) arranged in sequence and parallel along a length direction of the board-side module housing are provided in the board-side module housing; the high-power terminals and the signal wafers are respectively disposed in the first accommodating cavities and the second accommodating cavities; a first position-limiting slot (e.g., 111A) is provided on an upper end of the first accommodating cavity; a first elastic arm (e.g., 121) is provided at one end of the high-power terminal adjacent to the first position-limiting slot, and the first elastic arm obliquely extends away from the high-power terminal into the first position-limiting slot; a tail portion (e.g., 122) is provided at one end of the high-power terminal away from the first elastic arm, and the tail portion extends downward to the outside of the board-side module housing.
22. The connector according to aspect 21, wherein a second position-limiting slot (e.g., 111B) is provided on an inner sidewall of the first accommodating cavity, and a first projection (e.g., 123) corresponding to the second position-limiting slot is provided on an outer sidewall of the high-power terminal, and the first projection extends away from the high-power terminal into the second position-limiting slot.
23. The connector according to aspect 21, wherein a detent (e.g., 124) is respectively provided at upper and lower ends of the high-power terminal, and the two detents are respectively located on one side of the first elastic arm and the tail portion.
24. The connector according to any one of aspects 21 to 23, wherein the signal wafer comprises a wafer housing (e.g., 131) and a group of signal terminals (e.g., 132) provided in the wafer housing; a first end of the group of signal terminals extends downward to the outside of the wafer housing towards a lower side away from the wafer housing, and a second end of the group of signal terminals extends toward a lateral side of the wafer housing and extends to the outside of the wafer housing.
25. The connector according to aspect 24, wherein a third position-limiting slot (e.g., 112A) is respectively provided on two inner sidewalls of the second accommodating cavity, and a second projection (e.g., 131A) corresponding to the third position-limiting slot is provided on an outer sidewall of the wafer housing, and the second projection extends away from the wafer housing into the third position-limiting slot.
26. The connector according to aspect 24, wherein a fourth position-limiting slot (e.g., 112B) is provided on an upper end of the second accommodating cavity, a second elastic arm (e.g., 131B) corresponding to the fourth position-limiting slot is provided on the upper end of the wafer housing, and the second elastic arm extends upward into the fourth position-limiting slot towards an upper side away from the wafer housing.
27. The connector according to aspect 24, wherein the cable-side connector module comprises a cable-side module housing (e.g., 210) and a plurality of low-power terminal subassemblies (e.g., 220); a plurality of third accommodating cavities (e.g., 211) arranged in parallel along a length direction of the cable-side module housing are provided in the cable-side module housing, and the low-power terminal subassemblies are inserted into the third accommodating cavities; the low-power terminal subassembly comprises a low-power terminal (e.g., 221) and a cable (e.g., 222), and the low-power terminal is located in the cable-side module housing; one end of the cable is connected to the low-power terminal, and the other end extends to the outside of the cable-side module housing.
28. The connector according to aspect 27, wherein a first TPA slot (e.g., 211A) is provided on an upper end of the third accommodating cavity, a second TPA slot (e.g., 211B) corresponding to the first TPA slot is provided at a bottom of the third accommodating cavity, and a TPA (e.g., 211C) is inserted between the first TPA slot and the second TPA slot; a tab (e.g., 221A) is provided on a side of the low-power terminal adjacent to the TPA, and the tab is snapped on a side of the TPA away from the cable; a guiding member (e.g., 600) is provided on each of the board-side module housing and the cable-side module housing.
29. The connector according to aspect 24, wherein a circuit board is connected below the board-side connector module and the cable-side connector module, and the circuit board is provided with a first contact pad and a second contact pad; one end of the tail portion located outside the board-side module housing is electrically connected inside the first contact pad, and a first end of the group of signal terminals extends downward to the outside of the wafer housing towards a lower side away from the wafer housing, and is electrically connected inside the second contact pad.
30. The connector according to aspect 24, wherein a groove (e.g., 113) is provided at one side of the board-side module housing, the cable-side connector module is provided with a block (e.g., 212) corresponding to the groove, and the cable-side connector module is connected through a snap-fit connection of the groove with the block.
31. A hybrid board-and-cable connector configured to support high current, comprising a board-side connector module (e.g., 100) and a cable-side connector module (e.g., 200), wherein the board-side connector module (e.g., 100) is detachably connected to the cable-side connector module (e.g., 200); the board-side connector module (e.g., 100) comprises a board side module housing (e.g., 110), a high-power terminal (e.g., 120), and a signal wafer (e.g., 130); the high-power terminal (e.g., 120) and the signal wafer (e.g., 13) each are provided with a limiting structure to respectively mount the high-power terminal (e.g., 120) and the signal wafer (e.g., 130) in the board side module housing (e.g., 110); the cable-side connector module (e.g., 200) comprises a cable side module housing (e.g., 210), a low-power terminal (e.g., 221) and a cable (e.g., 222); the low-power terminal (e.g., 221) is mounted in the cable side module housing (e.g., 210) via a TPA (e.g., 211C); and the cable (e.g., 222) is provided and connected on the low-power terminal (e.g., 221).
32. The connector according to aspect 31, further comprising a circuit board (e.g., 400), wherein the board-side connector module (e.g., 100) is soldered on the circuit board (e.g., 400).
33. The connector according to aspect 32, wherein a side of the cable-side connector module (e.g., 200) is mounted with the board-side connector module (e.g., 100) through a block (e.g., 212), and the cable-side connector module (e.g., 200) is mounted on the circuit board (e.g., 400) through a fastener.
34. The connector according to aspect 33, wherein the fastener penetrates the cable-side connector module (e.g., 200) and the circuit board (e.g., 400) for mounting.
35. The connector according to aspect 31, wherein a detent (e.g., 124), a first elastic arm (e.g., 121) and a first projection (e.g., 123) are provided on the high-power terminal (e.g., 120) to form the limiting structure to mount the high-power terminal (e.g., 120) in the board side module housing (e.g., 110).
36. The connector according to aspect 31, wherein a second elastic arm (e.g., 131B) and a second projection (e.g., 131A) are provided on the signal wafer (e.g., 130) to form the limiting structure to mount the signal wafer (e.g., 130) in the board side module housing (e.g., 110). 37. The connector according to aspect 36, wherein positioning convex ribs are provided in the board side module housing (e.g., 110) to position and mount the signal wafer (e.g., 130).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, in some embodiments, the aspects of the present disclosure may not be limited to right angle connectors. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear”, “upper”, “lower”, “left”, “right”, “transverse direction”, “vertical direction”, “perpendicular”, “horizontal”, “top”, “bottom” and the like are shown based on the accompanying drawings, for the purposes of the ease in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. In some embodiments, various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector comprising:
a first module comprising:
a first module housing comprising a plurality of first cavities and a plurality of second cavities disposed in parallel along a longitudinal direction of the first module housing,
a plurality of first terminals each at least partially disposed in a respective first cavity of the plurality of first cavities, each of the plurality of first terminals comprising a mating end, and a tail portion configured for board termination, and
a plurality of wafers each at least partially disposed in a respective second cavity of the plurality of second cavities, each of the plurality of wafers comprising a wafer housing and a plurality of second terminals held by the wafer housing, each of the plurality of second terminals comprising a mating end, and a tail configured for board termination; and
a second module detachably attached to one side of the first module, the second module comprising a plurality of third terminals configured for cable termination.

2. The electrical connector of claim 1, wherein:
the first housing comprises a groove; and
the second module comprises a second housing comprising a block configured to engage the groove of the first housing.

3. The electrical connector of claim 2, wherein:
the block is dovetail-shaped.

4. The electrical connector of claim 1, wherein:
the first housing comprises a plurality of convex ribs on inner sidewalls of the first and second cavities.

5. The electrical connector of claim 1, wherein:
each of the plurality of first cavities comprises a first position-limiting slot; and
each of the plurality of first terminals comprises a first elastic arm extending into the first position-limiting slot in a respective first cavity.

6. The electrical connector of claim 1, wherein:
each of the plurality of first terminals comprises one or more detents at a top and/or bottom of the first terminal.

7. The electrical connector of claim 1, further comprising:
a polyester film disposed on an upper surface of the first housing.

8. The electrical connector of claim 1, wherein:
each of the plurality of second cavities comprises a second position-limiting slot; and
the wafer housing comprises a second elastic arm extending into the second position-limiting slot in a respective second cavity.

9. The electrical connector of claim 8, wherein:
each of the plurality of second cavities comprises a third position-limiting slot on an inner sidewall; and
the wafer housing comprises a projection disposed in the third position-limiting slot.

10. The electrical connector of claim 1, further comprising:
first and second guiding members disposed on the first housing of the first module and the second housing of the second module, respectively.

11. The electrical connector of claim 1, wherein:
each of the plurality of first terminals is configured to carry a first maximum current;
each of the plurality of second terminals is configured for signal transmission; and
each of the plurality of third terminals is configured to carry a second maximum current less than the first maximum current.

12. A connector module for board termination, comprising:
a module housing comprising a plurality of first cavities and a plurality of second cavities, each of the plurality of first cavities comprising a first position-limiting slot and a second position-limiting slot, each of the plurality of second cavities comprising a third position-limiting slot;
a plurality of high-power terminals disposed in the plurality of first cavities, each of the plurality of high-power terminals comprising a first elastic arm extending into the first position-limiting slot of a respective first cavity, a first projection engaging the second position-limiting slot of the respective first cavity, and a tail portion extending beyond the module housing; and
a plurality of signal wafers disposed in the plurality of second cavities, each signal wafer comprising a wafer housing and a plurality of signal terminals, the wafer housing comprising a second elastic arm engaging the third position-limiting slot of a respective second cavity.

13. The connector module of claim 12, wherein:
each of the plurality of second cavities comprises a fourth position-limiting slot on an inner sidewall; and
the wafer housing of each of the plurality of signal wafer comprises a second projection on an outer sidewall engaging the fourth position-limiting slot.

14. The connector module of claim 12, wherein:
the module housing comprises convex ribs extending in parallel on inner walls of the first cavities and second cavities and configured to enhance stability and heat dissipation.

15. The connector module of claim 12, wherein:
each of the plurality of high-power terminals comprises a tail portion comprising a plurality of tails aligned in a first line;
each of the plurality of signal terminals comprises a tail; and
the tails of the plurality of signal terminals of each of the plurality of signal wafers are aligned in a second line parallel to the first line.

16. A connector module for cable termination, comprising:
a module housing comprising a plurality of cavities disposed in parallel along a longitudinal direction of the module housing, each of the plurality of cavities comprising first and second slots;
a plurality of terminals disposed in the cavities, each of the plurality of terminals comprising a mating end and a tail; and
a plurality of terminal position assurance (TPA) devices, each of the plurality of TPA devices inserted between the first and second slots of a respective cavity of the module housing.

17. The connector module of claim 16, wherein:
each of the plurality of TPA devices extends through the first slot into the second TPA slot of the respective cavity, positioning the TPA device and a respective terminal side by side.

18. The connector module of claim 16, wherein:
each of the plurality of terminals comprises a tab snapped into engagement with the TPA device.

19. The connector module of claim 16, further comprising:
a plurality of cables, each of the plurality of cables comprising an end attached to the tail of a respective terminal of the plurality of terminals.

20. The connector module of claim 16, wherein:
the module housing comprises a block on a side and configured to engaging a complementary groove of a connector module configured for board termination, and a guiding member on a top and configured to engage a complementary guiding feature of a mating connector module.
